(19) United States
(12) Patent Application Publication
(10) Pub. No.: US 2008/0117452 A1
(43) Pub. Date: May 22, 2008

(54) Secure Printing System and Method for the Same

(75) Inventor: Koji Murakami, Tokyo (JP)

Correspondence Address: NORRIS, MCLAUGHLIN & MARCUS, P.A., 875 THIRD AVE, 18TH FLOOR, NEW YORK, NY, 10022, US

(73) Assignee: COMPUTER ENGINEERING & CONSULTING, LTD., Kanagawa (JP)

(21) Appl. No.: 11/779,582

(22) Filed: Jul. 18, 2007

(30) Foreign Application Priority Data
Nov. 22, 2006 (JP) 2006-314955

(51) Int. Cl. G06F 3/12

(52) U.S. Cl. 358/1.15

(57) ABSTRACT

To provide a secure printing system configured such that even if a designated printer is unavailable, printing can be performed with another printer without regard to the difference in models.

The secure printing system comprises: a client PC for creating print data for secure printing; one or more printers for performing printing; an authentication data acquisition means provided for each of the printers to obtain the authentication data of a user who creates the print data and a print control PC wherein there is a step in which if the client PC creates the print data, then it holds the print data therein as well as notifying the print control PC of at least authentication information on the user; a step in which if the authentication data acquisition means obtains authentication information on the user, then it sends the authentication information to the print control PC along with information on a corresponding printer; a step in which the print control PC performs an authentication using these pieces of authentication information; a step in which if the authentication is successful, then the print control PC notifies the client PC of a print approval along with the information on the printer; a step in which the client PC sends the print data to the printer; and a step in which the printer performs printing are performed.

### BACKGROUND OF THE INVENTION

1. Field of the Invention

The present invention relates to a secure printing system and method for the same, and more particularly, to a secure printing system and method for the same in which even if a designated printer becomes unavailable for some reason, printing can be performed with another printer without regard to the difference in model.

2. Description of the Related Art

In office environments or the like with networks, a configuration in which a printer is shared by multiple users is often used. In such an environment, when classified documents that include personal information such as archival records and pay statements, trade secrets of companies, or asset information are printed using a shared printer, other users of that printer may possibly be able to view those documents.

That is, since with ordinary printers printing starts immediately after the print job has been sent, any user printing a classified document needs to move to where the printer is right after sending the print job and obtain the document printed before it can be seen by anybody else. In this case, while it is relatively easy to print a classified document and obtain it before it is seen by others if the shared printer is not being used by others or the printer is located within view of the user, if the shared printer is performing a print job from another user or is not located within view of the user the printed classified document may possibly be read by others.

In order to address this inconvenience, a secure printing system configured such that printing a classified document is spooled to the printer itself or a print server along with individual identification information such as a fingerprint, and then when a user reaches the printer to actually print the document out and upon providing authentication the printer starts printing has been put into practical use in recent years (e.g., Patent Document 1).

A printing system with authentication has also been proposed, in which if a printer receiving a secure print job is unavailable for some reason such as being out of ink or being used to print another person's job, the print job is transferred to another printer and notification of that transfer is sent to the user (e.g., Patent Document 2). Patent Document 2 describes that printing can be normally performed even with a printer of a different model by referring to the status of the printer to which the print job is to be transferred, setting the time to start the transfer with consideration taken to the time needed to move to the printer to which the print job was transferred, and rewriting the header of the intermediate language of the print job.

Patent Document 1: Japanese Patent Laid-Open No. 2001-051915

Patent Document 2: Japanese Patent Laid-Open No. 2005-327123

However, the system in Patent Document 2 has the problem of not being able to ensure security because if the printer receiving a print instruction is in use or out of order, the printed material may be seen by someone else than the user that sent the print instruction if the print job is transferred to a printer without any authentication function. Therefore, considering that a procedure in which printing starts after the user that sent the print instruction has been authenticated is employed, the system has the inconvenience that printing cannot be performed unless the user instructs another printer that has an authentication function.

Furthermore, considering any case where it is desirable to reduce the risk of carrying around classified documents or data, which arises from creating a classified document at one site and then printing it at a second, if the printer at the second site is not within the same network, it is unknown whether or not the printer is connected, and therefore in a conventional system, the instruction to print cannot be given. And even in such a case, it would be convenient if the classified document could be printed after the user has moved to the second site and carried out individual authentication.

### SUMMARY OF THE INVENTION

It is therefore the objective of the present invention to realize secure printing, inexpensively and simply, even in a hardware environment where printers without any authentication function are used, and provide a system configured such that the user him/herself that has provided the print instruction is only able to print classified documents after they have been authenticated. Another objective of the present invention is to provide a system configured such that classified documents can be printed using a designated printer, even if detailed information on the printer is unknown because the printer belongs to a different network, or for any other reason. A further objective of the present invention is to provide a system configured such that even if the printer designated at the time of the print instruction is unavailable for some reason, printing can be performed with a printer of a different model without requiring the user to return to his/her desk to change the driver and then resend the print instruction again.

In order to solve the problems described above, a secure printing system of the first invention herein is comprised of: a client PC for sending print requests for secure printing; one or more printers for performing printing; authentication data acquisition means provided for each of the printers to obtain the authentication data of the user who sends the print request; and a print control PC for managing the one or more printers, the client PC, the one or more printers, the authentication data acquisition means, and the print control PC being respectively connected through a network, wherein if the client PC creates some print data, then it holds the print data therein as well as notifying the print control PC of at least the authentication information on the user; if the authentication data acquisition means obtains authentication information on the user, then it provides that authentication information to the print control PC along with information on the corresponding printer; and if authentication information from the client PC and that from the authentication data acquisition means agree with each other, then the print control PC notifies the client PC with information on the printer to allow the client PC to send the print data to the printer for printing.

In this secure printing system, it is effective that if a printer driver used to create the print data does not correspond to the printer of which the print control PC has been notified, the client PC automatically starts an application used to create the print data, invokes data that is the source of the print data, recreates print data using a driver corresponding to the printer notified by the print control PC and sends it to the printer.

It is also effective that if a printer driver used to create the print data does not correspond to the printer of which the print control PC has been notified and if an application used to create the print data is running, then the client PC recreates the print data using a driver corresponding to the printer of which the print control PC has been notified, through document data or a database currently held by the application, and sends it to the printer.

A secure printing system of a second invention herein comprises: a client PC for creating print data for secure printing; one or more printers for performing printing; authentication data acquisition means provided for each of the printers to obtain authentication data of a user who creates the print data; a print control PC for receiving the authentication data from the authentication data acquisition means and issuing a print approval and a document management server for temporarily storing the print data with the client PC, the one or more printers, the authentication data acquisition means, the print control PC, and the document management server being respectively connected through a network, wherein if the client PC creates the print data, then it sends the print data to the document management server as well as notifying the print control PC of at least authentication information on the user; if the authentication data acquisition means obtains authentication information on the user, then it sends the authentication information to the print control PC along with information on the corresponding printer, and if these segments of authentication information agree with each other, then the print control PC notifies the document management server of the information on the printer to allow the document management server to send the print data to the printer for printing.

In this secure printing system, it is effective that the client PC sends the print data to the document management server as a file in a general electronic document format or an image data format, and the document management server opens the file, creates the print data for the printer of which the document management server has been notified, and sends it to the printer.

It is also effective that the document management server comprises a storage area having stored drivers for various printers, extracts a corresponding driver based on the information on the printer of which the print control PC has been notified, creates the print spool data and sends it to the printer.

In any of the secure printing systems described above, it is desirable that the authentication data acquisition means be a card reader, and the print control PC performs an authentication of the user based on the recorded content of a card sent from the authentication data acquisition means and a number of readings of the card.

It is also desirable that the authentication based on the number of readings of the card is performed in such a way that if a card reading by the card reader has been performed within a predetermined time period since a previous reading, 1 is added to the number of readings, and if the predetermined time period has passed without another reading since the previous reading, the number of readings by then is compared to a number of times having been set. Then if the number of readings does not agree with the number of times having been set and if the number of readings exceeds the number of times having been set by a number of times randomly determined for each authentication, the card reader notifies the user of an authentication failure, and if the notification is repeated a predetermined number of times, printing of the print data is denied.

It is effective that any of the secure printing systems described above further comprises a card reader/writer provided for the client PC, and the client PC records at least the authentication information about the user in the card through the card reader/writer when the client PC creates the print data.

A third invention herein relates to the print control PC constituting the secure printing system described above, and the print control PC is characterized by comprising: a first storage area for storing the authentication data of the user received from the client PC; a second storage area for storing the authentication data and the information on the printer received from the authentication information acquiring means; authentication means for checking the authentication data in the first storage area and in the second storage area against each other, and print approval notifying means for sending a print approval notice to the client PC or the document management server along with the information on the printer in the second storage area if the authentication is successful.

A fourth invention herein relates to a print control program running on the printer control PC, and the print control program is characterized by causing the print control PC to perform the steps of: receiving the authentication information on the user from the client PC to accumulate it in the first storage area; storing the authentication data and the information on the printer received from the authentication information acquisition means in the second storage area; extracting the authentication data in the first storage area and that in the second storage area to check them against each other, and sending the print approval notice to the client PC or the document management server along with the information on the printer in the second storage area if the authentication is successful

A fifth invention herein relates to the document management server constituting the secure printing system described above, and the document management server is characterized by comprising: a first storage area for accumulating files received from the client PC; a second storage area in which various applications and various printer drivers are preliminarily registered and print control means for opening the files and sending the print spool data to the printer of which the print control PC has been notified when the print control means receives a print approval from the print control PC.

A sixth invention herein relates to a program running on this document management server, and the program is characterized by causing the document management server to perform the steps of: storing a file received from the client PC in the first storage area; and opening the file and sending the print spool data to the printer of which the print control PC has been notified when the print approval from the print control PC is received.

A seventh invention herein relates to a program running on the client PC described above, and the program is characterized by causing the client PC to perform the steps of: monitoring the print command of an application instructing to print; retaining the print spool data in the PC itself if the print command is detected, and sending to the print control PC the authentication information on the user who issues the print command and outputting the print spool data to the printer of which the print control PC has been notified if a print approval notice is sent from the print control PC.

An eighth invention herein is a secure printing method in a secure printing system comprising: a client PC for creating print data for secure printing; one or more printers for performing printing; an authentication data acquisition means provided for each of the printers to obtain authentication data of the user who creates the print data with the print control PC, the client PC, the one or more printers, the authentication data acquisition means, and the print control PC being respectively connected through a network, and the secure printing method is characterized by comprising: a step in which if the client PC creates the print data, then it holds the print data therein as well as notifying the print control PC of at least authentication information on the user; a step in which if the authentication data acquisition means obtains authentication information on the user, then it sends the authentication information to the print control PC along with information on a corresponding printer; a step in which the print control PC performs an authentication using these segments of authentication information; a step in which if the authentication is successful, then the print control PC notifies the client PC of a print approval along with the information on the printer; a step in which the client PC sends the print data to the printer and a step in which the printer performs the printing.

In this method, it is effective that the step of sending the print data from the client PC to the printer comprises a step in which if a printer driver used to create the print data does not correspond to the printer of which the print control PC has been notified, the client PC automatically starts an application used to create the print data, invokes data that is a source of the print data, recreates print data using a driver corresponding to the printer of which the print control PC has been notified and sends it to the printer.

It is also effective that the step of sending the print data from the client PC to the printer comprises a step in which if a printer driver used to create the print data does not correspond to the printer of which the print control PC has been notified and if an application used to create the print data is running, then the client PC recreates print data using a driver corresponding to the printer of which the print control PC has been notified, through a document data or a database currently held by the application and sends it to the printer.

A ninth invention herein is a secure printing method in a secure printing system comprising: a client PC for creating print data for secure printing; one or more printers for performing printing; an authentication data acquisition means provided for each of the printers to obtain authentication data for the user who creates the print data; a print control PC for receiving the authentication data from the authentication data acquisition means and issuing a print approval and a document management server for temporarily storing the print data with the client PC, the one or more printers, the authentication data acquisition means, the print control PC, and the document management server being respectively connected through a network, and the secure printing method is characterized by comprising: a step in which if the client PC creates the print data, then it sends the print data to the document management server as well as notifying the print control PC of at least authentication information on the user; a step in which if the authentication data acquisition means obtains authentication information on the user, then it sends the authentication information to the print control PC along with information on a corresponding printer; a step in which the print control PC performs an authentication using these pieces of authentication information; a step in which if the authentication is successful, then the printer control PC notifies the document management server of the information on the printer; a step in which the document management server sends the print data to the printer and a step in which the printer performs printing.

In this method, it is effective that the client PC creates the print data as a file in a general electronic document format or an image data format and sends it to the document management server.

It is also effective that the document management server comprises a storage area having stored interface drivers for various printers, and a step in which the document management server sending the print data to the printer comprises a step in which the document management server uses a corresponding driver based on the information on the printer of which the print control PC has been notified, to create print spool data and sends it to the printer.

In any of the methods described above, it is effective that the authentication data acquisition means is a card reader, and the step in which the print control PC performs an authentication is carried out by performing an authentication of the user using the recorded content of a card sent from the authentication data acquisition means and using a number of readings of the card.

In this case, it is effective that the step in which the print control PC performs an authentication is carried out in such a way that if a card reading by the card reader has been performed within a predetermined time period since a previous reading, 1 is added to the number of readings; and if the predetermined time period has passed without another reading since the previous reading, the number of readings by then is compared to a number of times having been set. Then, if the number of readings does not agree with the number of times having been set and if the number of readings exceeds the number of times having been set by a number of times randomly determined for each authentication, the card reader notifies the user of an authentication failure, and if the notification is repeated a predetermined number of times, printing of the print data is denied.

In the invention according to claim 1 herein, the print data is retained in the client PC used to create it and sent to a printer from the client PC based on an authentication by the authentication means provided for each of the printers. Since it is configured so that the print data is retained in the client PC, a conventional printer in which printing is performed upon reception of a data can be used without modification, and also it is not necessary to install a document server for accumulating the print data between the client PC and the printer, whereby secure printing can be realized at low cost and with a simple configuration. Also, even if a printer primarily designated as the output destination by the client PC is unavailable for reasons such as being out of order or being occupied, the print control PC notifies the client PC of information on another printer, and the print data is sent to the printer as the output destination if a user moves to the site of the printer and inputs authentication information into an authentication device. This enables another printer to output a classified document even if the primarily designated printer is unavailable.

According to the invention of claim 2 herein, if a user selects a printer of a different model when a primarily designated printer is unavailable, the application used to create the print data is automatically started to open the source data, and print spool data for the newly selected printer is recreated for outputting, since the spool data for the primarily designated printer cannot be used. This enables the user to change printer models so as to output a classified document without returning to his/her desk to reissue a print command.

According to the invention of claim 3 herein, if source data is not saved but the application is still open, the print data is output to the new printer using the document data currently held by the application or the database. This enables a classified document to be output with another printer of a different model even if data that is a print source is not saved.

According to the invention of claim 4 herein, once the data to be printed is sent to the document management server from the client PC, and the print spool data is output from the document management server to the printer that the user has moved to and performed the authentication for, this enables any printer incorporated in the system to output a document without regard to the difference in model even if the connection of the printer to which a user desires to output cannot be detected because it belongs to a different network, or for other reasons, or even if at the time of instructing it to print, the user does not know which printer is nearest to an intended site.

According to the invention of claim 5 herein, document data is sent to the document management server as a file in a general electronic document format or an image data format such as pdf or bmp. This enables the document management server to create the print spool data without regard to the type of application used to create a document on a client PC. Particularly, even if data to be printed is created using an application (e.g., addressing software) which has a configuration not providing a file with a layout definition, instead of an application (e.g., word processor or spreadsheet) with which a document or an image file is input on a client PC and then output, the data can be temporarily stored in the document server as a print image data for printing.

According to the invention of claim 6 herein, since the document management server comprises the various printer drivers, the spool data can be created using the driver corresponding to the printer for which the user has performed the authentication. It is desirable that such printer drivers cover all kinds of printers available on the market, to which new drivers are periodically added. Even in such cases, difference in printer models can be accommodated with significantly less time and effort when compared to incorporating various printer drivers into each client PC.

According to the invention of claim 7 herein, the authentication is performed based on the number of card readings by the card reader, so that, for example, a card reader connected to a network can be used as an authentication device. Also, in this case, an existing card reader can be preferably used without having to provide a device such as a numeric keypad for entering a password.

According to the invention of claim 8 herein, a card reading within the predetermined time period since the previous reading increases the number of card readings, and if the time period has passed, the number of card readings is then determined. If the determined number of card readings does not agree with the number of times having been set, the authentication fails. Also, if the number of readings exceeds the number of times having been set by the number of times randomly determined for each authentication, the user is notified of the authentication failure. This configuration enables authentication to be provided using the number of readings the user has consecutively made with the card to be read. Also, it is ensured that an error determination in the case where the number of readings exceeds the number of times having been set can be made, and thus the problem in which a card reading is endlessly repeated in excess of the number of times having been set can be avoided.

According to the invention of claim 9 herein, the number of card readings and other authentication information used for each authentication can be written on a card at the time of creating a print job on each of the client PCs so that the system can be operated as a simple and effective authentication system. Also, for example, the card may be configured so as to be necessary for logging on a client PC or used as a card for entering a room or a building where the client PC is installed, whereby a high-security printing system can be provided in combination with an operational method of the present invention.

In addition, the present invention relates to a print control PC, a document control server, a program operating on such a terminal or a client PC, and an operational method of the secure printing system described above, all of which are for realizing the secure printing system, and by configuring and utilizing the secure printing system by using them, even if an intended printer is unavailable, a user can definitely obtain a printout using another printer without regard to the difference in model.

### DESCRIPTION OF THE DRAWINGS

FIG. 1 is a schematic diagram showing a configuration of Example 1 according to the present invention.

FIG. 2 is a schematic diagram showing a software configuration of the client PC 11 shown in FIG. 1.

FIG. 3 is a schematic diagram showing a software configuration of the print control PC 19 shown in FIG. 1.

FIG. 4 is a diagram for explaining the operations in Example 1 shown in FIG. 1.

FIG. 5 is a flowchart for explaining the control process of a knock authentication according to the present invention.

FIG. 6 is a diagram for explaining operations when an initially intended printer is unavailable in Example 1 shown in FIG. 1.

FIG. 7 is a schematic diagram showing a configuration of Example 2 of the secure printing system according to the present invention.

FIG. 8 is a schematic diagram showing the software configuration in the document management server shown in FIG. 7.

FIG. 9 is a diagram for explaining the operation of Example 2 shown in FIG. 7.

FIG. 10 is a schematic diagram showing a configuration of Example 3 of the secure printing system according to the present invention.

FIG. 11 is a diagram showing one example of network configuration information managed according to Example 3.

### DETAILED DESCRIPTION OF THE INVENTION

The best mode for carrying out the present invention is described below with reference to the accompanying drawings.

### EXAMPLE 1

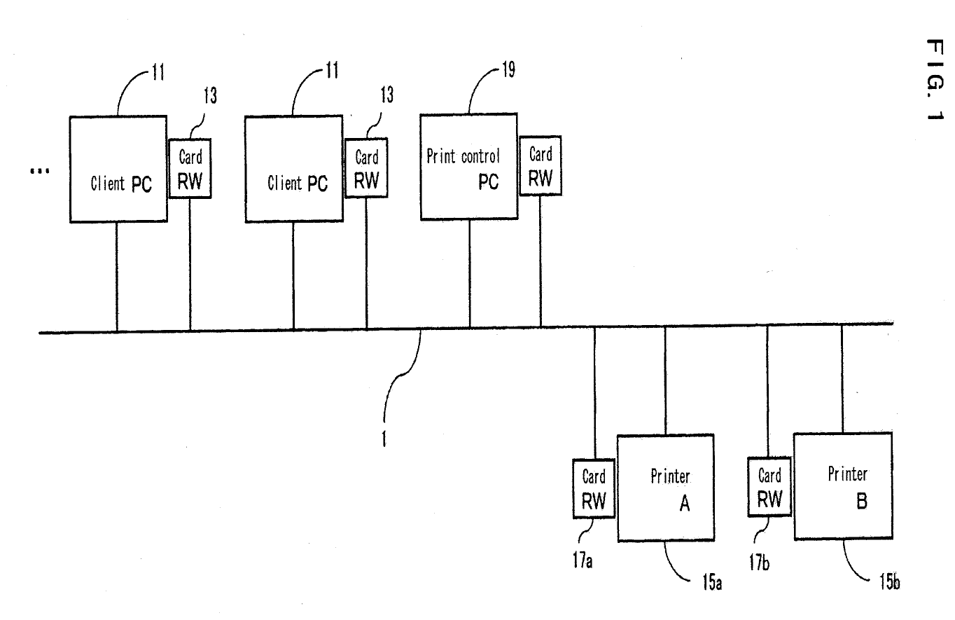

FIG. 1 is a schematic diagram showing a configuration of Example 1 according to the present invention. A secure printing system of this example is configured as, for example, an office LAN comprising one or more client PCs 11, a card reader/writer (hereinafter referred to as card RW) 13 provided for each of the client PCs, one or more printers 15 connected to the network 1, a card RW 17 provided for each of the printers, and a print control PC 19.

Since this example supposes a secure printing system using an IC card, any of the card RWs 13 and 17 is described as a contact type reader/writer for the IC card. However, another example may employ a configuration using a magnetic card or another type of card. Also, the printer 15 of this example is assumed to be a network printer which has a printer server function and is directly connected to the network 1, but it may be a printer connected to any of the PCs on the network 1. Further, the card RW 13 for a client PC may be incorporated in the client PC 11, or it may be configured to be physically independent and connected to the client PC 11 or the network 1. The card RW 17 for the printer has a similar configuration, but since the printer 15 in this example is an existing printer without an authentication function, the card RW 17 is provided on the side of each printer to allow the existing printer to be effectively used in the configuration shown.

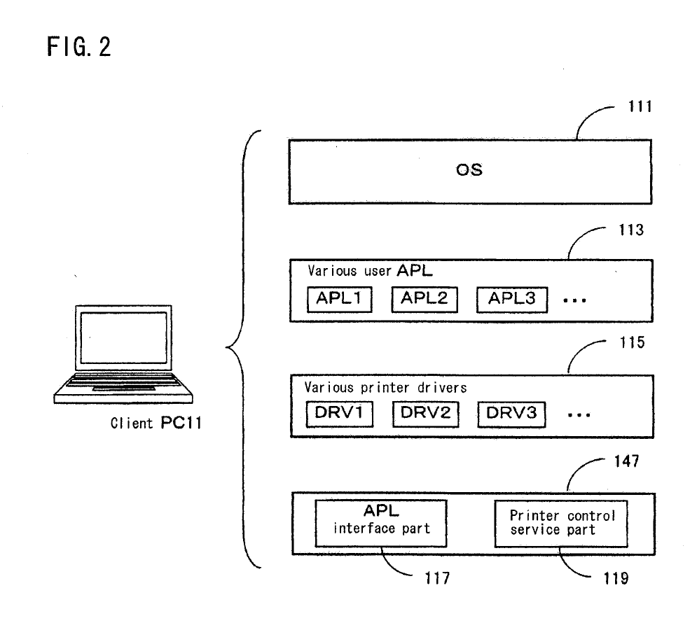

FIG. 2 is a schematic diagram for illustrating the software configuration of the client PC 11. The client PC 11 is, for example, a personal computer that a user uses in an office and comprises input/output devices such as a monitor, a keyboard, and a mouse and components provided for an ordinary computer, such as a CPU, memory, and a HDD. As shown in FIG. 2, the software configuration of the client PC 11 comprises an operating system (OS) 111, various user applications (APL) 113, various printer drivers (DRV) 115, an APL interface part 117, and a printer control service part 119. The various user APLs 113 are any applications used by the user, such as word-processing software, spreadsheet software, image processing software and addressing software with which a print job is created. The various printer drivers 115 are drivers for creating print spool data for respectively different printer models, and each of the client PCs 11 preferably has the drivers for all of the printers connected to the network 1. The APL interface part 117, although is described in detail below, is a program module that processes a print request command and performs a writing process into an IC card through the card RW 13. The printer control service part 119 is a module that changes settings on the printer driver 115 to stop a printer spool, receives a print approval from the print control PC 19 and starts an appropriate application to recreate a print job. The client PC 11 constituting the system of the present invention is characterized by newly comprising the APL interface part 117 and the printer control service part 119. These modules 117 and 119 are to be installed in the client PC along with the various printer drivers at the time of introducing the system.

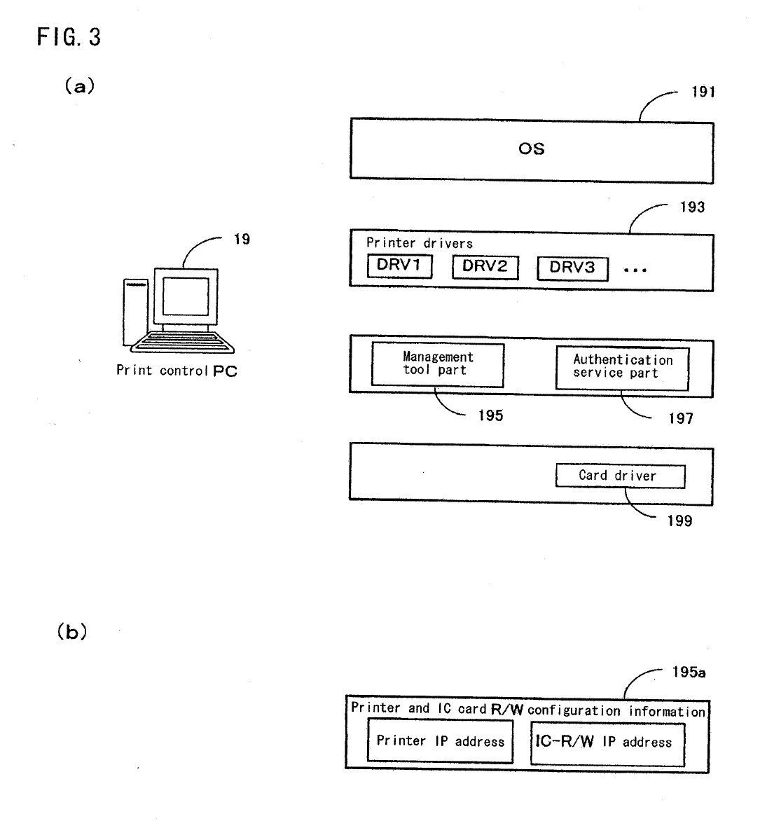

FIG. 3(a) is a schematic diagram illustrating a software configuration of the print control PC 19. The print control PC 19 is a computer terminal that manages secure printing by a printer connected to the network 1. As shown in the diagram, the print control PC 19 comprises an OS 191, various printer drivers 193, a management tool part 195, and an authentication service part 197. The various printer drivers 193 at least include drivers for all of the printers 15 connected to the network 1. The management tool part 195, although described in detail below, is a module that receives a print job data from the client PC in order to manage it and issues a print approval to the client. The authentication service part 197 performs user authentication based on information from the card RW 17 provided for each of the printers 15. FIG. 3(b) is a table 195a for printer-card RW configuration information which the management tool part 195 manages in its storage area and in which the IP address of each of the printers 15 connected to the network 1 and the IP address of the card RW 17 provided correspondingly to each of the printers are registered as pairs of information. The print control PC 19 has a driver 199 that controls a number of card RWs 17 provided at the respective sides of the printers. In addition, various functions of the print control PC 19 may be incorporated into any of the client PCs 11 or a document management server described below.

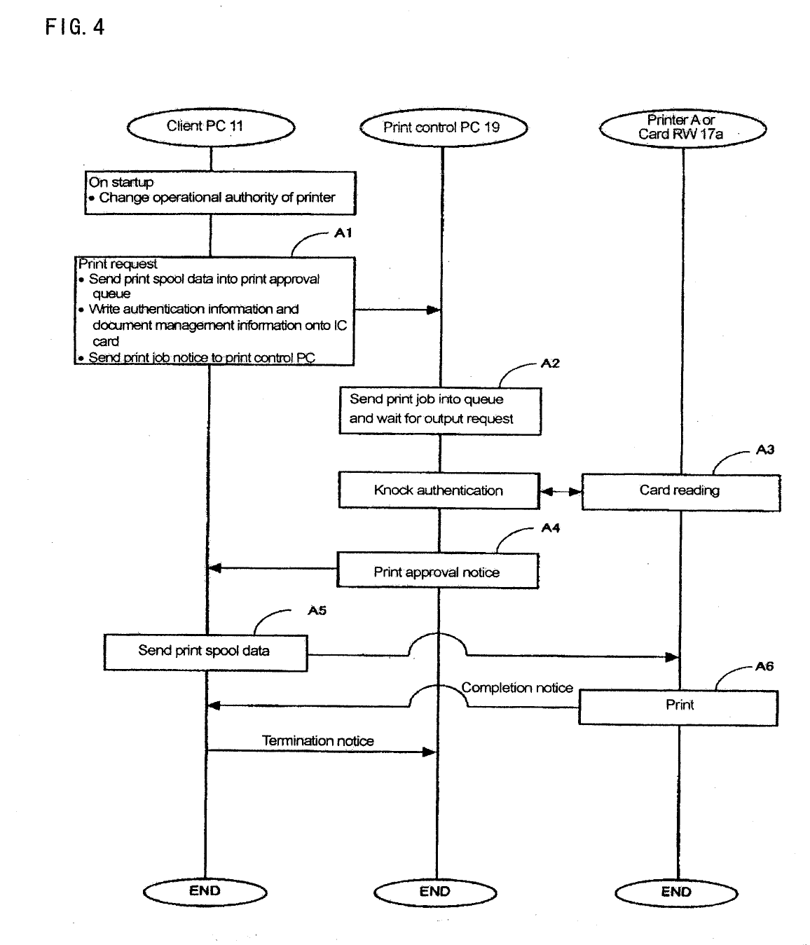

With reference to FIG. 4 and subsequent figures, operations of the system are described below. The programs 117 and 119, the various printer drivers 115, and the arbitrary applications 113 required in advance are installed in the client PC 11, and the APL interface part 117 and the printer control service part 119 are configured to be resident in the client PC 11 on its start-up. In the table 195a (see FIG. 3b) of the print control PC 19, the IP address of each of the printers on the network 1 and the IP address of the corresponding card RW 17 are registered. The card RWs 17 are configured to be controlled by the card driver 199 in the print control PC 19 and treated as peripheral devices of the print control PC 19 on the network. When adding a new printer to the network 1, the operator's input allows information on the card RW corresponding to the printer to be registered in the table 195a via the management tool part 195 of the print control PC 19.

When a user operates the client PC 11 and designates any printer A and issues a print command from an application, the client PC 11 does not output spool data created by a driver based on the print command directly to the printer A but sends the data to a print approval queue, as well as sending a print job notice to the print control PC 19 and writing information on it onto the IC card (step A1).

The print job notice sent to the print control PC 19 is equivalent to the information written onto the IC card and includes identification information for identifying the user, identification information on the client PC issuing the print command (the model identification name and the IP address), information on the document to be printed ( the document file path in the client PC), printing software information for identifying the application used to instruct to print, and the number of IC card readings (hereinafter referred to as “knock count”) which is required at the time of the print request. The knock count is the number of times a user moves to the site of the printer to have an IC card read by the card RW, and one of the features of the present invention is that the knock count is used for individual authentication. Regarding the knock count, when the user issues instructions to print, the APL interface part 117 asks the user to set a number of times, and the user sets any number. The default value of the knock count is 1. This knock count authentication is explained in the following description about authentication in more detail.

When the print control PC 19 receives a print job notice from the client PC 11, it registers the job in a database along with information on the received date and time, and waits for a print request from a printer site (step A2).

The user then moves to the site of the printer A with the IC card, and has the card RW 17 installed alongside read the IC card knock count which was set at the time of the print request (step A3). This becomes an output request and the print control PC 19 performs an authentication by using the content of the card and the knock count.

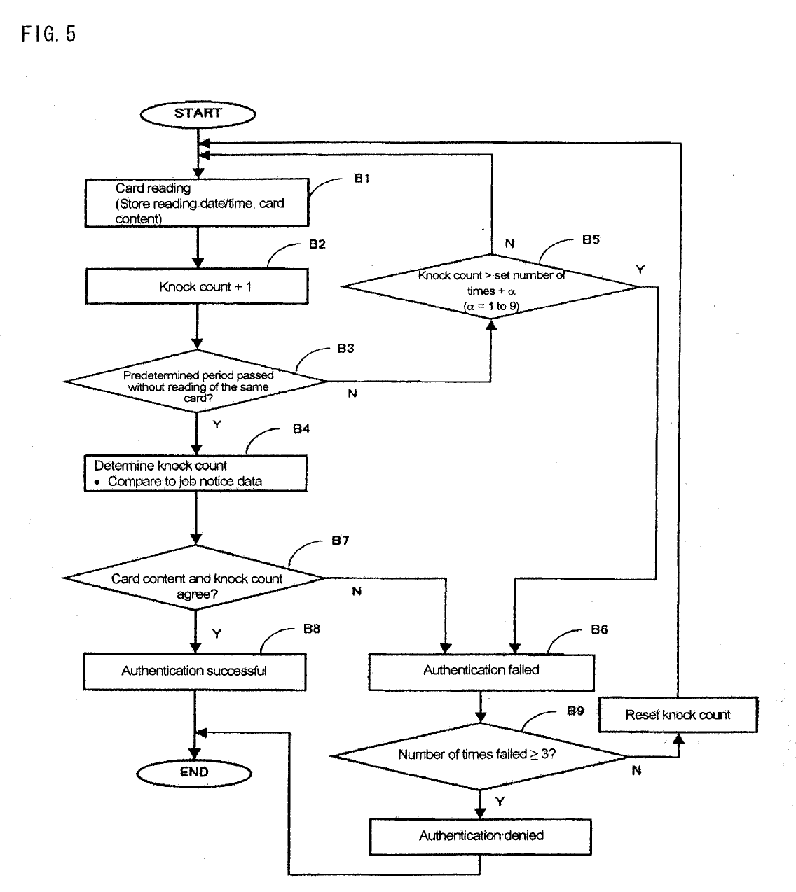

The knock count authentication to be performed here is described in detail with reference to FIG. 5. When the IC card is read by the card RW 17 on the side of any of the printers, its content is sent to the print control PC 19 (step B1). At this time, the reading date/time and the reading content are stored in the print control PC 19. The print control PC 19 increases the knock count by 1 and waits for a predetermined time period (e.g., for 5 seconds) (step B2). If the card has been read again within the time period (step B3: N), then step B1 is repeated, and the knock count is increased by 1 again in step B2. At this time, if the knock count exceeds the number obtained by adding a number from 1 to 9 randomly determined for each authentication to the knock count that the user has set with the client PC 11 (step B5), the user is notified of an authentication failure (step B6). This can prevent an unauthorized user from making repeated use of the card. It is preferable that the card RW 17 outputs a reading confirmation sound every time the card is read and also that the user be notified of the success/failure of the authentication by voice and/or a screen display.

On the other hand, if the same card has not been read within the predetermined time period since the previous reading (step B3: Y), the number of readings by then is considered as the knock count and compared with the knock count that has been set and is present in the job notice or the card content (step B4). If the card content corresponds to the knock count (step B7: Y), the authentication is successful (step B8). If the card content does not correspond to the knock count (step B7: N), the user is notified of the authentication failure (step B6).

In this example, even if the authentication fails, a retry is allowed up to three times. If the authentication fails, the card content and the fact of the authentication failure are stored, and if three successive authentication failures take place (step B9), the user is notified of an authentication denial (step B10).

When authentication is denied, the print job data related to the user is deleted by the print control PC 19, and the client PC 11 is notified of the denial and deletes the print spool data, whereby the user cannot obtain any printout.

Thus, user authentication can be performed using the number of times the user makes the card RW 17 read the IC card. Also, the process in step B5 prevents an unauthorized user from continuing to read a card over and over, and even if the authentication fails, a retry is allowed up to three times. In addition, the number “three times” may be modified.

If the authentication is successful, the print control PC 19 sends a print approval notice to the client PC 11 identified by the content which has been read (step A4 in FIG. 4). The print approval notice includes the identification information on the client PC (the model identification name and the IP address), identification information on the designated output printer (the model identification name and the IP address), the document information (the path indicating the location in the client PC where the document to be printed is stored), and the APL information for identifying the application used to instruct to print. The printer control service part 119 of the client PC 11 receives the notice, checks the contents such as the printer information, and redirects the corresponding spool data waiting for an output approval to an output queue to return the control to the driver, whereby the spool data is sent to the printer A from the client PC 11 (step A5). Upon receipt of it, the printer A (printer 15a) performs printing (step A6). If the printing is successfully completed, the printer 15a sends a completion report to the client PC 11, and the printer control service part 119 of the client PC 11 sends a completion notice to the print control PC 19. The print control PC 19 changes the status of the print job data managed therein to a normal end, and completes the process.

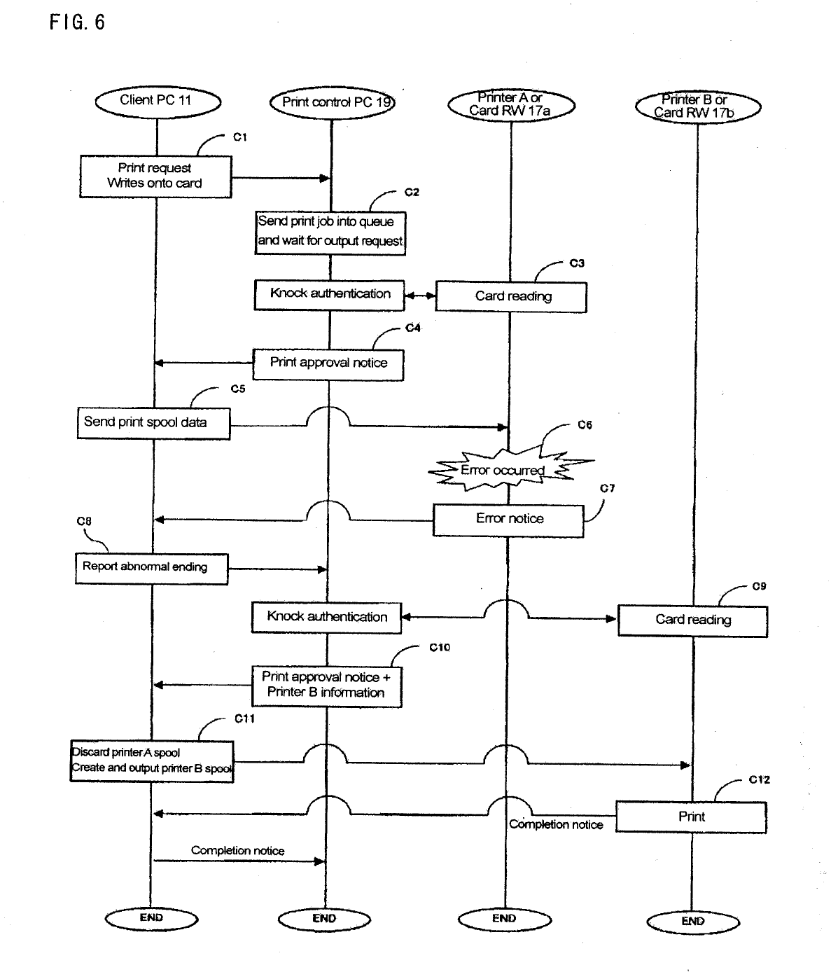

The example described above is the case where the printer A which the user initially desired to use for output is available for printing without problems, and the user definitely obtains a printout by sending a print job, then moves to the printer A, and performs an authentication. However, there may be a case where the user finds that the printer A is occupied by another user and unavailable to him/her after he/she has moved to the printer A. Also, there may be a case where the printer A is unavailable due to being out of ink, out of paper, or other malfunctions. Even in such cases, the present invention is configured to enable secure printing using a printer that the user arbitrarily selects. With reference to FIG. 6, operations in such cases are described below.

If the user sends a print request from the client PC 11, identification information and document information are written onto the IC card through the card RW 13, and the same information is sent to the print control PC 19 as print job data (step C1), which is managed in a job queue (step C2). Subsequently, when the user moves to the site of the intended printer A and performs a knock authentication (step C3), the print control PC 19 sends a print approval notice to the client PC 11 that created the print job (step C4), and the client PC 11 outputs the spool data to the printer A (step C5). The process so far is just as shown in the operation example in FIG. 4.

Assume that an error occurs due to a paper jam or being out of ink while the printer A prints (step C6). The printer A notifies the client PC 11 of the error occurrence (step C7). This is a function that conventional printers are normally equipped with. When the printer control service part 119 of the client PC 11 receives the notice, it reports an abnormal end to the print control PC 19 (step C8). The print control PC 19 changes the status of the print job managed therein to an abnormal end.

In this case, the user further moves to a printer B (printer 15b), which is not in use and not out of order, and performs the same knock authentication as that performed at the printer A with the use of the card RW 17b provided to the printer B (step C9). The print control PC 19 identifies the print job based on the content of the read card, understands from the card RW 17b that the user is now at the site of the printer B, and sends a print approval notice to the client PC 11 along with information on the printer B (step C10). When the printer control service part 119 of the client PC 11 receives the notice, it discards or changes the spool data for the printer A, and when possible, creates spool data for the printer B to send it to the printer B (step C11).

More specifically, if the printer of which the printer control service part 119 is notified with the print approval is the same model as the printer for the spool data in the print approval queue, the printer control service part 119 of the client PC 11 changes the address of the designated output printer and outputs the original data without modifying it because the original spool data can be used.

On the contrary, if the printer of which the printer control service part 119 is notified with the print approval is a different model from the printer for the spool data in the print approval queue, or if there is no spool data in the print approval queue, it starts a word processing application based on the document APL information or the path of the document included in the notice, opens the document, changes the printer driver to that corresponding to the printer B of which the printer control service part 119 is notified, and executes the print command to output the spool data to the printer B. The reason why the case where no spool data exists in the client PC is included here is to illustrate that a printout can be obtained as long as the data of the print job remains in the print control PC even if the spool data in the client PC disappears for some reason. If the document has already been opened on the client PC 11 at the time when the print approval notice for another printer is received, the printer control service part 119 simply designates the printer B and creates print spool data to send it. Also, for example, there may be a case where a user simply creates a file and sends a print request without saving it. In order to accommodate such a case, if the file does not exist in a document file path of which the printer control service part 119 is notified, or if the document file path does not exist in a print approval notice and an application identified by APL information has already been started, the printer control service part 119 designates the printer B and issues a print instruction through the document data currently held by the application. Further, if the running program is addressing software or the like in which each record is extracted from a database and printed independently, it designates the printer B and issues a print instruction through the database currently held. Still further, if the application has already been closed, the print control PC 19 and the printer B are notified that the spool data cannot be recreated. Still further, for example, user data in an address list and addressing software is, for example, in a CSV format, which does not have a mode in which a file cannot be simply opened for printing, so that if the APL information identifies an application employing such a mode, a notice stating that spool data cannot be recreated is sent, similarly to the above case.

Thus, even if the printer A, which was initially intended to be used for printing, is out of order for some reason, a user can obtain a printout from another printer B by moving to the site of the printer B and performing a knock authentication. Further, even if the initially designated printer A is unavailable to the user because it is occupied by someone else, the user can obtain a printout through the processing in step C9 and the subsequent steps in FIG. 6 if the user moves to the site of another printer B and performs a knock authentication.

In addition, the print control PC is adapted to periodically check the print job queue and delete any print job for which printing has not been performed or a completion notice has not been sent even after a predetermined time period has elapsed from a registration.

### EXAMPLE 2

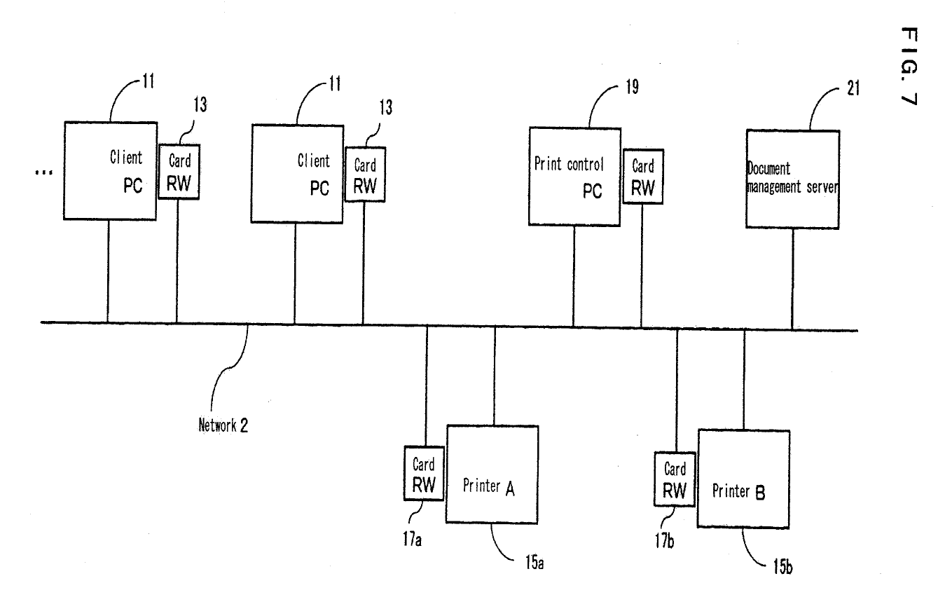

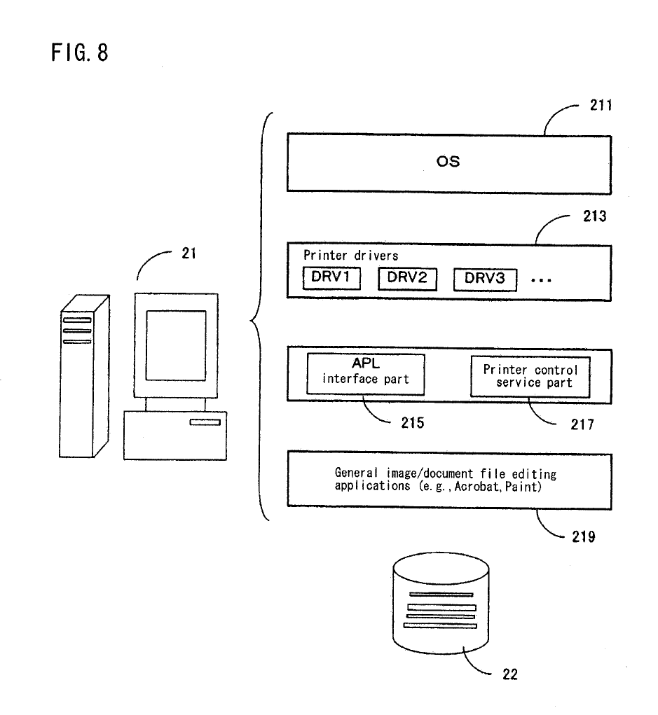

Example 2 of the present invention is now described in detail with reference to FIG. 7. FIG. 7 is a schematic configuration diagram of a secure printing system according to Example 2 of the present invention. In this example, in addition to the configuration shown in FIG. 1, a document management server 21 for temporarily storing a file to be printed is connected to a network 2. FIG. 8 shows a software configuration in the document management server 21. As shown in FIG. 8, the document management server 21 comprises an OS 211, various printer drivers 213, an APL interface part 215, a printer control service part 217 and a predetermined editing application 219 for general imaging or a document file. The document management server 21 also comprises a storage device 22 with a capacity sufficient to temporarily store the general image/document file sent from each of client PCs 11. Further, although not shown in this example, the editing application 219 for a general image or a document file same as in the document management server 21 is also installed in each of the client PCs 11. The application 219 is image/document editing software for creating a print image data upon receipt of a print command from a user application running on the client PC, for which software preferably employed may include, but is not particularly limited to, for example, Acrobat by Adobe Systems Incorporated for creating pdf files or Microsoft Paint for creating bmp files (both are registered trademarks).

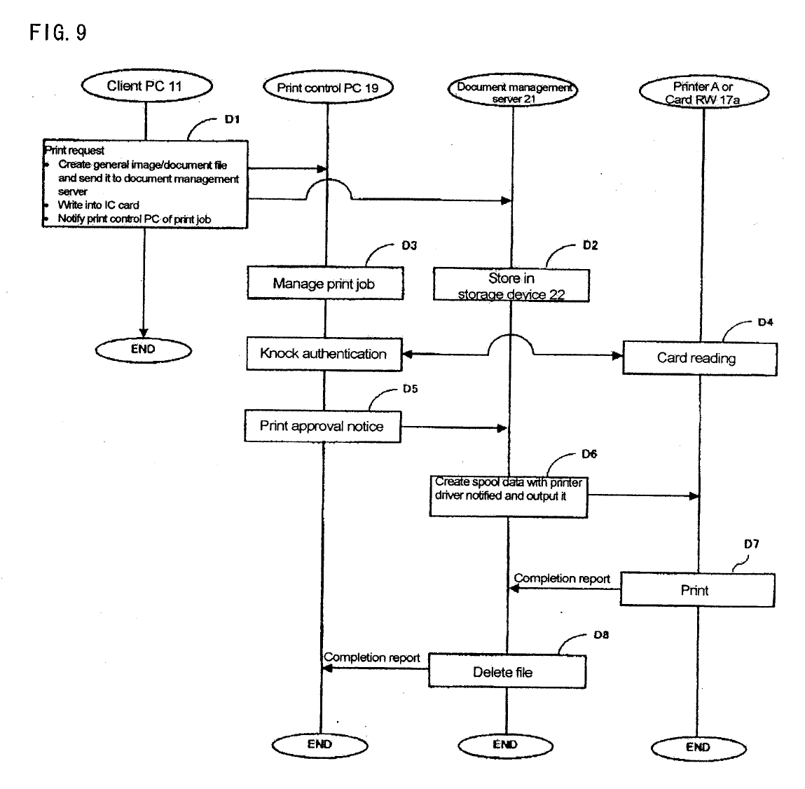

A control process in Example 2 is described below with reference to FIG. 9. When a print request is sent from any of the client PCs 11, the APL interface part 117 of the client PC 11 starts the editing application 219, creates a file for print image data, and sends it to the document management server 21. More specifically, for example, when a user issues a print command using word processing software, Acrobat (registered trademark) is started, and the print data is converted into a pdf file, which is then sent to the document management server 21. Also, the client PC 11 creates a print job data to write it onto an IC card and send it to the print control server 19 (step D1). As in Example 1, the print job data includes user identification information including setting a knock count, information on the document name and path and information on the APL used to create the file. In this example, a primary print command may be issued with or without designating a printer. In such a case, if one virtual printer driver that is preliminarily created in the client PC 11 is selected, it can be considered that no specific printer is designated. If a specific printer is designated, information on it (model and IP address of the printer) is included in the print job data.

When the document management server 21 receives the print image data file, it stores the data in its storage area along with information on the received date/time and source client PC (step D2). On the other hand, the print control PC 19 sends the received print job data to a job queue to manage it (step D3).

Subsequently, the user takes out the IC card and moves to the site of the desired printer. At that time, the user may shut down the client PC 11 with which he/she has instructed to print.

The user moves to the site of the desired printer (e.g., printer A) and performs a knock authentication with the card RW 17a provided to the printer A (step D4). The knock authentication is the same as in Example 1 (see FIG. 5), so that a detailed description about it is omitted here to avoid duplication. If the knock authentication is successful, the print control PC 19 sends a print approval notice to the document management server 21 (step D5). The print approval notice includes the content of the print job data and the information on the printer A. When the printer control service part 217 of the document management server 21 receives the print approval information, it specifies the print image file in the storage procedure 219 based on the information, opens it with the editing application 219, creates spool data using the driver for the printer A of which the document management server 21 is notified, and outputs it (step D6). This enables the printer A to print the spool data, and the user to directly obtain a printout. If the printing is successful, the document management server 21 deletes the corresponding stored file upon receipt of a completion report from the printer, and sends a completion notice to the print control PC 19.

Configuring and operating the system as described above enable the user to shut down (power discontinuity) the client PC at his/her desk after issuing the print command, move to the printer site to perform printing, and obtain the printout him/herself. In this example, even if the printer A, which was primarily intended to be used for printing, is unavailable due to occupancy by someone else or malfunction, the print control PC 19 sends the print approval for another printer B to the document management server 21, then the spool data for the printer B is created, and printing is performed with the printer B if the user further moves to the site of the printer B and performs the knock authentication. At this time, even if the printer A was primarily designated through the client PC 11, the print control PC 19 understands that the printer A is not being used, based on the fact that it received an output request (knock authentication) from the printer B, and changes the information on the designated output printer to the information on the printer B. Thus, even if the location of a printer is not known because, for example, the user is on a different floor in his/her company, or for other reasons, the user can tentatively designate a known printer or a virtual driver, then issue a print command, and perform printing with an appropriate printer after moving to the site of the printer.

In addition, this example has a configuration in which print image data is converted into a file for image/document editing software for creating a print image and sent from the client PC 11 to the document management sever 21, but it may have a configuration in which a copy of the data file to be printed is sent from the client PC 11 to the document management server 21, and the document management server opens the file to create print spool data after a printer to be used has been determined by a print approval notice. In this case, it is desirable that all printable user applications used by users on the network 2 are installed in the document management server 21. In this example, when the document management server 21 receives a print approval notice, it starts a corresponding application to open the file, and at this point, print spool data is eventually created. Even if such a procedure is employed, a user can obtain a printout with a desired printer.

A further variation of this example may have a configuration in which when the client PC 11 issues a print command, the print image/document data is converted and sent to the document management server 21 (step D1 in FIG. 9), and print spool data is created within the client PC 11 and managed in the print approval queue as in the example shown in FIG. 1. In this case, when the print control PC 19 receives an output request from any of the printers 15, it first sends a print approval notice to the client PC 11 from which the print command was issued. If the client PC 11 is on at this time, it sends the spool data to the printer, and printing is started, similarly to the operation in the example shown in FIG. 1. Also, if an output request is sent from the printer B that is different from the primarily intended printer A, the editing application is started, the file is opened, and spool data for the printer B is output. On other hand, if the client PC 11 is off (power interrupted), the inability to send the print approval notice is detected so that the print control PC 19 changes the destination of the print approval notice to the document management server 21 and sends it. This allows processing in step D5 and the subsequent steps in FIG. 9 to be performed, whereby the spool data is output to the printer from the document management server 21 to perform printing. In this case, since the print approval notice is not sent even if the client PC 11 is turned on afterward, the print control service part 119 of the client PC 11 is adapted to delete any spool data which has not been output and is in the print approval queues after an appropriate time period has passed.

### EXAMPLE 3

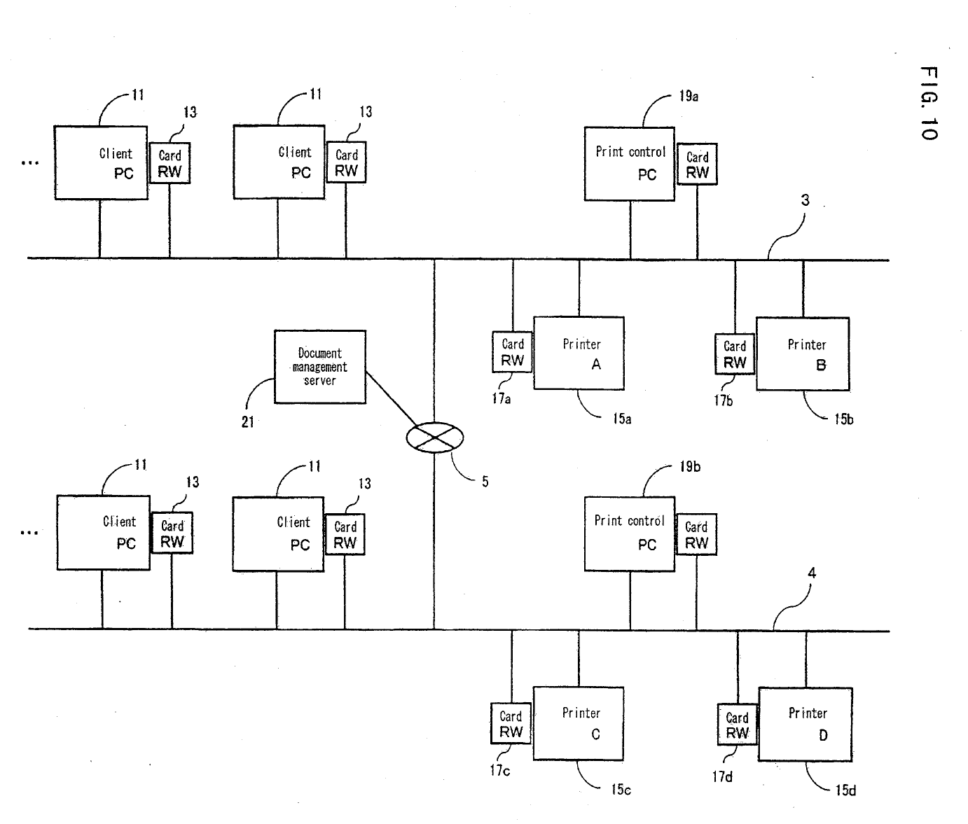

FIG. 10 is a schematic diagram showing a configuration of Example 3 of the present invention. This example provides a secure printing system applied to a configuration in which two remote LANs 3 and 4, for example, a network within a Tokyo office and that within an Osaka office in the same company, are connected through a wide area network 5. As shown in FIG. 10, the LAN 3 and the LAN 4 are connected through the wide area network 5. Each of the LANs 3 and 4 has a configuration like the network 1 shown in FIG. 1, that is, each of the LANs comprises a number of client PCs 11, a number of printers 15, and one print control PC 19, and card RWs 13 and 17 are provided for each of the client PCs and each of the printers respectively. Print data for each of the printers 15 on the LANs 3 and 4 is managed by the print control PC 19 within the LAN to which each of the printers belongs. Further, this system has one document management server 21. The document management server 21 in this example is connected to the wide area network 5; however, the document management server 21 is not limited to this example but may be configured to be connected to either the LAN 3 or 4.

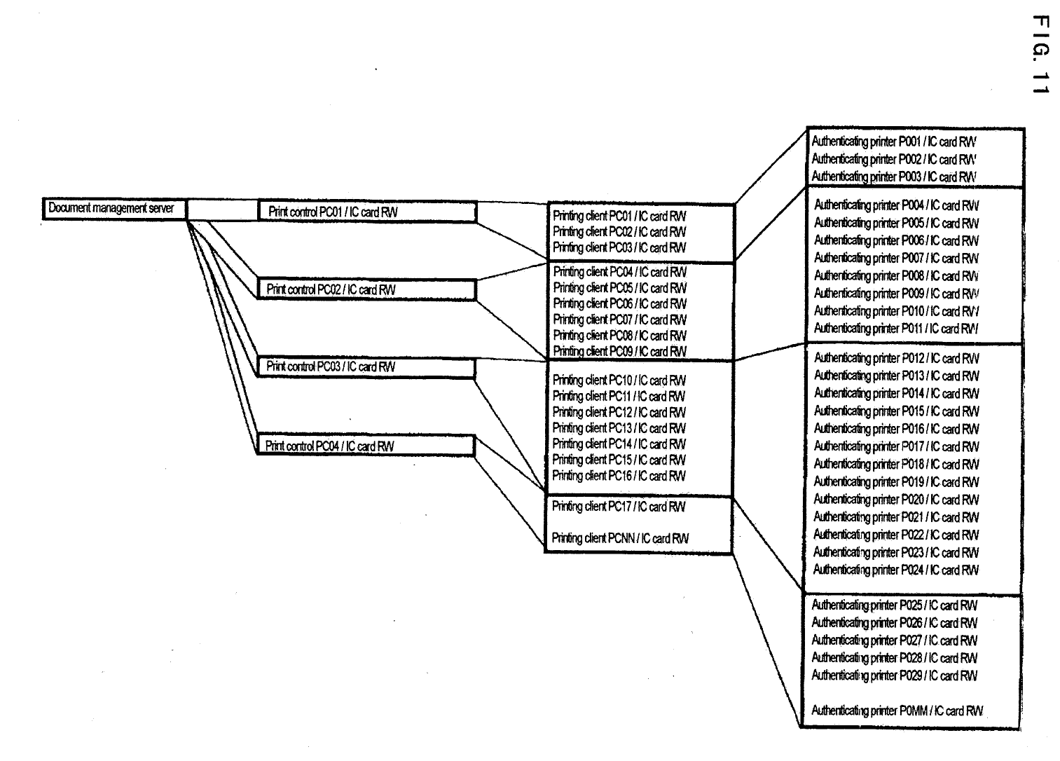

In this system, the document management server 21 and each of the print control PCs 19 at a minimum share the network configuration information as shown in FIG. 11. Information on the client PCs and printers constituting each of the LANs 3 and 4 is gathered into each of the print control PCs 19a and 19b respectively, which is further gathered into the document management server 21, and the gathered information is entirely fed back. That is, when a new printer is connected to the LAN, information on it (model name and IP address) is registered in the print control PC 19, and corresponding configuration information is gathered into the document management server 21 and summarized as shown in FIG. 11. Also, the summarized list is periodically sent to each of the print control PCs 19 and client PCs 11. In this way, each of the client PCs 11 and print control PCs 19 is adapted to obtain information on the devices constituting the entire secure printing system. As shown in FIG. 11, by referring to the network configuration information, each of the print control PCs is adapted to understand the information on each of the printers that it manages.

In this example, when a user operates any of the client PCs 11 and designates an output printer with reference to the network configuration information shown in FIG. 11 and issues a print command, the client PC 11 converts the print data into a general image/document file to be send t to the document management server 21, and at the same time, notifies the print control PC, which manages the printer, of the print job with reference to the network configuration information, and the print job is managed by the print control PC. Subsequently, performing the processing in step D4 and the subsequent steps in FIG. 9 allows a user to send a print command to a printer connected to a different LAN. For example, the user sends the print command from a Tokyo office to an Osaka office and uses a desired printer for outputting after he/she has moved to the Osaka office. In this case, even if a printer connection is not directly checked because the printer is on a different LAN from the LAN to which the client PC is connected, it is possible to designate the printer and register a print job in the print control PC managing the printer.

In addition, in a manner similar to a variation in Example 2, this example may have a configuration in which a print image file is sent to the document management server while the print spool data is held in the client PC, or a configuration in which a copy of a file itself related to a print command is sent to the document management server 21 from the client PC 11, and the document management server 21 comprising various applications starts a corresponding application to perform printing upon receipt of a print approval. Further, if an initially intended printer is unavailable due to being used by someone else or some malfunction, similar to the cases of the previous two examples, another printer may be adapted to output if it conducts an output request (knock authentication).

The configurations and operations of the several examples of the present invention have been described above; however, this invention is not limited to the above configurations, but may be realized in a number of variations and applications. For example, in any of the examples, the output request and authentication are performed based on the knock authentication; however, the authentication may be one using biological information such as a fingerprint or a voiceprint, or may employ an authentication method such as a simple password entry. Also, in the above examples, one print control PC is provided for each LAN to manage a print job for a printer connected to the LAN; however, the print control PC is not limited to one PC for each network, but two or more print control PCs may be connected to one network, each of which may handle several printers. Further, any of the above examples provides a secure printing system using an IC card; however, the IC card may further be utilized as an individual authentication item for a security system. For example, an authentication function for a building entry/exit system or a PC logon system may be added to the IC card, and a print control PC may be configured to manage information on the systems and deny any output request by a person who has not entered the building or has logged on at a different site.

### INDUSTRIAL APPLICABILITY

The secure printing system of the present invention allows for the configuration of a secure printing system using an existing printer that starts printing upon receipt of print spool data, in which a user moves to the site of the printer and performs an authentication, and then printing is started. Also, even if an initially intended printer is unavailable, another printer of a different model can be designated for outputting. This secure printing system can be applied to any industry where output onto a paper medium is required through a network and is utilized particularly in information-technology industries.

### EXPLANATION OF THE NUMBERS

1 to 4: Local area network
5: Wide area network
11: Client PC
13: IC card reader/writer for client PC
15: Printer
17: IC card reader/writer for printer
19: Print control PC
21: Document management server
113, 219: Various user applications
115, 193, 213: Various printer drivers
117, 215: APL interface part
119, 217: Printer control service part
195: Control tool part
197: Authentication service part
195a: Configuration information on printer card RW
22: Storage device

1. A secure printing system comprising: a client PC for sending a print request for secure printing; one or more printers for performing printing; an authentication data acquisition means provided for each of the printers to obtain authentication data of a user who sends the print request and a print control PC for managing the one or more printers with the client PC, the one or more printers, the authentication data acquisition means, and the print control PC being respectively connected through a network,
wherein if the client PC creates print data, then it holds the print data therein as well as notifying the print control PC of at least the authentication information on the user; if the authentication data acquisition means obtains authentication information on the user, then it provides the authentication information to the print control PC along with information on a corresponding printer; and if the authentication information from the client PC and that from the authentication data acquisition means agree with each other, then the print control PC notifies the client PC of the information on the printer to allow the client PC to send the print data to the printer for printing.

2. The secure printing system according to claim 1, wherein if a printer driver used to create the print data does not correspond to the printer of which the print control PC has been notified, the client PC automatically starts an application used to create the print data, invokes data that is the source of the print data, recreates the print data using a driver corresponding to the printer of which the print control PC has been notified and sends it to the printer.

3. The secure printing system according to claim 1 wherein if a printer driver used to create the print data does not correspond to the printer of which the print control PC has been notified and if the application used to create the print data is running, then the client PC recreates the print data using a driver corresponding to the printer of which the print control PC has been notified through document data or a database currently held by the application and sends it to the printer.

4. A secure printing system comprising: a client PC for creating print data for secure printing; one or more printers for performing printing; an authentication data acquisition means provided for each of the printers to obtain authentication data of a user who creates the print data; a print control PC for receiving the authentication data from the authentication data acquisition means and issuing a print approval and a document management server for temporarily storing the print data with the client PC, the printers, the authentication data acquisition means, the print control PC and the document management server being respectively connected through a network,
wherein if the client PC creates the print data, then it sends the print data to the document management server as well as notifying the print control PC of authentication information on the user. If the authentication data acquisition means obtains authentication information on the user, then it sends the authentication information to the print control PC along with information on the corresponding printer; and if these pieces of authentication information agree with each other, then the print control PC notifies the document management server of the information on the printer to allow the document management server to send the print data to the printer for printing.

5. The secure printing system according to claim 4 wherein the client PC sends the print data to the document management server as a file in a general electronic document format or an image data format, and the document management server opens the file, creates print data for the printer of which the document management server has been notified, and sends it to the printer.

6. The secure printing system according to claim 4 wherein the document management server comprises a storage area having stored drivers for various printers, extracts a corresponding driver based on the information on the printer of which the print control PC has been notified, creates the print spool data and sends it to the printer.

7. The secure printing system according to claim 1 wherein the authentication data acquisition means is a card reader and the print control PC performs an authentication of the user based on the recorded content of a card sent from the authentication data acquisition means and a number of readings of the card.

8. The secure printing system according claim 7 wherein the authentication based on the number of readings of the card is performed in such a way that if a card reading by the card reader has been performed within a predetermined time period since a previous reading, 1 is added to the number of readings and if the predetermined time period has passed without another reading since the previous reading, the number of readings by then is compared to a number of times having been set, then if the number of readings does not agree with the number of times having been set and if the number of readings exceeds the number of times having been set by a number of times randomly determined for each authentication, the card reader notifies the user of an authentication failure, and if the notification is repeated a predetermined number of times, printing of the print data is denied.

9. The secure printing system according claim 1 further comprising a card reader/writer provided for the client PC wherein the client PC records the authentication information on the user in the card through the card reader/writer when the client PC creates the print data.

10. The print control PC constituting the secure printing system according to claim 1, comprising: a first storage area for storing the authentication data of the user received from the client PC; a second storage area for storing the authentication data and the information on the printer received from the authentication information acquisition means; an authentication means for checking the authentication data in the first storage area and that in the second storage area against each other and a print approval notifying means for sending a print approval notice to the client PC or the document management server along with the information on the printer in the second storage area if the authentication is successful.

11. A print control program running on the printer control PC according to claim 10, causing the print control PC to perform the steps of: receiving the authentication information on the user from the client PC and accumulating it in the first storage area; storing the authentication data and the information on the printer received from the authentication information acquisition means in the second storage area; extracting the authentication data in the first storage area and that in the second storage area to check them against each other and sending the print approval notice to the client PC or the document management server along with the information on the printer in the second storage area if the authentication is successful.

12. The document management server constituting the secure printing system according to claim 4, comprising: a first storage area for accumulating a file received from the client PC; a second storage area in which various applications and various printer drivers are registered beforehand and a print control means for opening the file and sending the print spool data to the printer of which the print control PC has been notified when the print control means receives a print approval from the print control PC.

13. A program running on the document management server according to claim 12 causing the document management server to perform the steps of: storing the file received from the client PC in the first storage area and opening the file and sending the print spool data to the printer of which the print control PC has been notified when the print approval from the print control PC is received.

14. A program running on the client PC according to claim 1 causing the client PC to perform the steps of: monitoring the print command of an application instructing to print; retaining the print spool data in the PC itself if the print command is detected, sending the authentication information on the user to the print control PC which issues the print command and outputting the print spool data to the printer of which the print control PC has been notified if a print approval notice is sent from the print control PC.

15. A secure printing method in a secure printing system comprising: a client PC for creating print data for secure printing; one or more printers for performing printing; an authentication data acquisition means provided for each of the printers to obtain authentication data of a user who creates the print data and a print control PC with the client PC, the one or more printers, the authentication data acquisition means, and the print control PC being respectively connected through a network,
the secure printing method comprising: a step in which if the client PC creates the print data, then it holds the print data therein as well as notifying the print control PC of at least authentication information on the user; a step in which if the authentication data acquisition means obtains authentication information, then it sends the authentication information to the print control PC along with information on a corresponding printer; a step in which the print control PC performs an authentication using these pieces of authentication information; a step in which if the authentication is successful, then the print control PC notifies the client PC of a print approval along with the information on the printer; a step in which the client PC sends the print data to the printer and a step in which the printer performs printing.

16. The secure printing method according to claim 15 wherein the step of sending the print data from the client PC to the printer comprises a step in which if a printer driver used to create the print data does not correspond to the printer of which the print control PC has been notified, the client PC automatically starts an application used to create the print data, invokes data that is the source of the print data, recreates the print data using a driver corresponding to the printer of which the print control PC has notified and sends it to the printer.

17. The secure printing method according to claim 15 wherein the step of sending the print data from the client PC to the printer comprises a step in which if a printer driver used to create the print data does not correspond to the printer of which the print control PC has been notified and if the application used to create the print data is running, then the client PC recreates the print data using a driver corresponding to the printer of which the print control PC has been notified through document data or a database currently held by the application and sends it to the printer.

18. A secure printing method in a secure printing system comprising: a client PC for creating print data for secure printing; one or more printers for performing printing; an authentication data acquisition means provided for each of the printers to obtain authentication data of the user who creates the print data; a print control PC for receiving the authentication data from the authentication data acquisition means and issuing a print approval and a document management server for temporarily storing the print data with the client PC, the one or more printers, the authentication data acquisition means, the print control PC, and the document management server being respectively connected through a network,
the secure printing method comprising: a step in which if the client PC creates the print data, then it sends the print data to the document management server as well as notifying the print control PC of at least authentication information on the user; a step in which if the authentication data acquisition means obtains authentication information on the user, then it sends the authentication information to the print control PC along with information on a corresponding printer; a step in which the print control PC performs an authentication using these pieces of authentication information; a step in which if the authentication is successful, then the printer control PC notifies the document management server of the information on the printer; a step in which the document management server sends the print data to the printer and a step in which the printer performs the printing.

19. The secure printing method according to claim 18, wherein the client PC creates the print data as a file in a general electronic document format or an image data format and sends it to the document management server.

20. The secure printing method according to claim 18 wherein the document management server comprises a storage area with stored interface drivers for various printers and a step in which the document management server sends the print data to the printer comprises a step in which the document management server uses a corresponding driver based on the information on the printer of which the print control PC has been notified to create the print spool data and sends it to the printer.

21. The secure printing method according to claim 15 wherein the authentication data acquisition means is a card reader and the step in which the print control PC performs an authentication is carried out by performing an authentication of the user using the recorded content of a card sent from the authentication data acquisition means and the number of readings of the card.

22. The secure printing method according to claim 21 wherein the step in which the print control PC performs an authentication is carried out in such a way that if a card reading by the card reader has been performed within a predetermined time period since a previous reading, 1 is added to a number of readings and if the predetermined time period has passed without another reading since the previous reading, the number of readings is then compared to a number of times having been set and if the number of readings does not agree with the number of times having been set and if the number of readings exceeds the number of times having been set by a number of times randomly determined for each authentication, the card reader notifies the user of an authentication failure and if the notification is repeated a predetermined number of times, printing of the print data is denied.
